(19) United States
(12) Patent Application Publication
(10) Pub. No.: US 2018/0283249 A1
(43) Pub. Date: Oct. 4, 2018

(54) EGR UREA HYDROLYSIS

(71) Applicant: JOHNSON MATTHEY PUBLIC LIMITED COMPANY, London (GB)

(72) Inventor: Jeremy GIDNEY, Royston (GB)

(21) Appl. No.: 15/935,429

(22) Filed: Mar. 26, 2018

Related U.S. Application Data
(60) Provisional application No. 62/477,545, filed on Mar. 28, 2017.

(51) Int. Cl. F01N 3/20; F01N 3/28; F01N 3/035; B01D 46/00; F02M 26/30; F02M 26/15; B01D 53/94

(52) U.S. Cl. CPC F01N 3/2066; F01N 3/28; F01N 3/035; B01D 46/0027; F02B 1/12; F02M 26/15; B01D 53/9431; B01D 53/9418; F02M 26/30

(57) ABSTRACT

An exhaust system for an internal combustion engine, comprising an exhaust gas recirculation (EGR) circuit for connecting an exhaust stream to an intake of the engine, wherein the EGR circuit comprises a heat exchanger and the heat exchanger includes a surface comprising a urea hydrolysis catalyst; and a urea injector for providing urea to the surface of the heat exchanger coated with the urea hydrolysis catalyst, and means for introducing resulting ammonia to the exhaust stream.

### BACKGROUND OF THE INVENTION

The invention relates to an exhaust system that contains an exhaust gas recirculation (EGR) circuit extracting the heat from this circuit to aid urea decomposition to augment the performance of an SCR system.

Internal combustion engines produce exhaust gases containing a variety of pollutants, including hydrocarbons, particulate matter, sulfur oxides, carbon monoxide, and nitrogen oxides (“NOₓ”), which include nitric oxide (NO), nitrogen dioxide (NO₂), and nitrous oxide (N₂O). Increasingly stringent national and regional legislation has lowered the amount of pollutants that can be emitted from such diesel or gasoline engines. Many different techniques have been applied to exhaust systems to clean the exhaust gas before it passes to atmosphere.

Exhaust gas recirculation (EGR) is a method for reducing NOₓ emissions from an engine by returning a portion of the engine's exhaust gas to the engine combustion chambers via the air intake. EGR works by lowering the oxygen concentration in the combustion chamber, thereby decreasing the peak temperature of the fuel combustion flame as well as through heat absorption. EGR has been used since the mid-1970s in gasoline fueled passenger car engines. Following the gasoline application, EGR was also introduced to diesel passenger cars and, from the early 2000s, to heavy-duty diesel engines.

Generally, there are two exhaust system arrangements comprising EGR: (i) high pressure loop EGR, in which the exhaust gas is recirculated from upstream of a turbocharger; and (ii) low pressure loop EGR (also called long loop EGR), where exhaust gas is often recirculated from downstream of a particulate filter, allowing all the exhaust gas to be utilized in the turbo.

The use of EGR systems has been taught in, for example, PCT Intl. Appl. WO 2012/120347 which discloses an exhaust system for a vehicular lean burn internal combustion engine that comprises a low pressure EGR circuit for connecting the exhaust system downstream of a filter to an air intake of the engine, wherein the EGR circuit comprises an ammonia oxidation catalyst. In addition, PCT Intl. Appl. WO 2012/114187 teaches an exhaust system for a vehicular lean burn internal combustion engine comprising a low pressure EGR circuit having a NOₓ adsorber catalyst (NAC) comprising a nitric oxide (NO) adsorbent.

As with any automotive system and process, it is desirable to attain still further improvements in exhaust gas treatment systems.

### SUMMARY OF THE INVENTION

According to some embodiments of the present invention, an exhaust system for an internal combustion engine includes (a) an exhaust gas recirculation (EGR) circuit for connecting an exhaust stream to an intake of the engine, wherein the EGR circuit comprises a heat exchanger and the heat exchanger includes a surface comprising a urea hydrolysis catalyst; and (b) a urea injector for providing urea to the surface of the heat exchanger coated with the urea hydrolysis catalyst, and means for introducing resulting ammonia to the exhaust stream. In some embodiments, the EGR circuit is a low pressure EGR circuit. In some embodiments, the EGR circuit is a high pressure EGR circuit.

The heat exchanger may include a surface contacted by the exhaust stream, which is catalytically coated to discourage soot accumulation. In some embodiments, the system may further include a selective catalytic reduction (SCR) catalyst, wherein the ammonia is introduced upstream of the SCR catalyst. In some embodiments, the selective catalytic reduction catalyst comprises a transition metal and molecular sieve. In some embodiments, an ammonia oxidation catalyst is disposed downstream of the SCR catalyst, relative to the direction of exhaust gas flow through the system. In some embodiments, the SCR catalyst and the ammonia oxidation catalyst are loaded onto the same substrate, wherein the SCR catalyst is located on an inlet end and the ammonia oxidation catalyst is located on an outlet end. The system may further include a particulate filter.

A lean-burn internal combustion engine may include an exhaust system as described herein. In some embodiments, the engine may be a compression ignition engine.

### BRIEF DESCRIPTION OF THE DRAWINGS

FIG. 1 is a schematic diagram of an embodiment of a heat exchanger configuration of the present invention.

FIG. 2 depicts a system including a diesel oxidation catalyst (DOC), followed by a means for introducing a nitrogenous reductant such as ammonia, followed by an SCR filter and an SCR/ammonia oxidation catalyst.

FIG. 3 depicts a system including a DOC followed by a catalyzed particulate filter, a means for introducing a nitrogenous reductant, then an SCR/ammonia slip catalyst.

FIG. 4 depicts a system including a NOx storage catalyst, followed by a means for introducing a nitrogenous reductant, followed by an SCRF, then an SCR/ammonia oxidation catalyst.

FIG. 5 depicts a system including a NOx storage catalyst, followed by a catalyzed particulate filter, followed by a means for introducing a nitrogenous reductant, then an SCR/ammonia oxidation catalyst.

### DETAILED DESCRIPTION OF THE INVENTION

Systems and method of the present invention relate to a new system that utilizes a heat exchanger within an EGR circuit. The heat exchanger serves to cool the EGR exhaust gas before it enters the engine intake, and efficiently uses that heat to ameliorate the process of hydrolyzing urea to ammonia to be injected upstream of a selective catalytic reduction (SCR) catalyst.

SCR technology is the predominant mechanism for NOₓ reduction in diesel exhaust aftertreatment systems. Generally, in the art, a urea solution is directly injected upstream of an exhaust mixing plate prior to its impingement on the SCR catalyst surface. Injection is typically avoided at low exhaust temperatures because the urea forms large deposits which may foul the injection system. In these conditions, ammonia surface storage is employed by the SCR catalyst. Exhaust temperature is often low on LDD applications because of sustained part load operation and improving engine efficiencies. In some cases, ammonia rather than urea is injected, as the urea solution contains water which takes energy to evaporate and the hydrolysis reactions that follow are endothermic. An independent source of heat would be ideal to ameliorate this process, but in general, this would sacrifice vehicle efficiency.

One free and unwanted source of heat does exist, however—namely the heat present in the EGR gas stream. Systems of the present invention seek to exploit this free energy, which will contribute both to EGR cooling and assisting urea hydrolysis. To achieve these benefits, systems of the present invention include a heat exchanger within the EGR circuit. The EGR circuit may be a low pressure EGR circuit, or a high pressure EGR circuit. The heat exchanger includes a surface with a urea hydrolysis catalyst; a urea injector provides urea to the surface of the heat exchanger with the urea hydrolysis catalyst. Meanwhile, the EGR gas flows through the other side of the heat exchanger. Such surface of the heat exchanger may be catalytically coated to discourage soot accumulation. By this mechanism, urea conversion to ammonia may be achieved and a contribution is made to the cooling of the EGR gas before it enters on the engine intake. The resulting ammonia may then be introduced to the exhaust stream, for example, upstream of an SCR catalyst.

Heat Exchanger

Systems of the present invention may include a heat exchanger within the EGR circuit. The heat exchanger may be configured to have a surface including a urea hydrolysis catalyst. In some embodiments, the urea hydrolysis catalyst is coated on the heat exchanger surface. In another embodiment, the heat exchanger surface is extruded to contain the urea hydrolysis catalyst. The hydrolysis catalyst comprises a material that catalyzes the conversion of urea to ammonia in the presence of water (or the conversion of isocyanic acid to ammonia in the presence of water). Suitable hydrolysis catalysts may include, but are not limited to, metals and metal oxides (e.g., transition metal oxides such as titania, zirconia; zeolites such as beta-zeolite, zsm-5 zeolite, ferrierite or chabazite, or SCR catalysts including vanadia-tungsten titania SCR, Fe zeolite SCR, Cu-zeolite SCR, or Ce-SCR).

The heat exchanger may be configured to have a surface which discourages soot accumulation. For example, such surface may be coated with transition metal oxides such as titania, zirconia; zeolites such as beta-zeolite, zsm-5 zeolite, ferrierite or chabazite, or SCR catalysts including vanadia-tungsten titania SCR, Fe zeolite SCR, Cu-zeolite SCR, or Ce-SCR.

The heat exchanger may be configured within the EGR circuit such that urea is provided to the surface having the urea hydrolysis catalyst, and the resulting ammonia may be added to the exhaust stream. The EGR gas may flow through the other side of the heat exchanger, thus becoming cooler before entering the engine intake.

SCR Catalyst

Systems of the present invention may include one or more SCR catalysts. The exhaust system of the invention may include an SCR catalyst which is positioned downstream of an injector for introducing reductant such as ammonia into the exhaust gas. In some embodiments, the SCR catalyst may be positioned directly downstream of the injector for injecting ammonia or a compound decomposable to ammonia (e.g. there is no intervening catalyst between the injector and the SCR catalyst).

The SCR catalyst includes a substrate and a catalyst composition. The substrate may be a flow-through substrate or a filtering substrate. When the SCR catalyst has a flow-through substrate, then the substrate may comprise the SCR catalyst composition (i.e. the SCR catalyst is obtained by extrusion) or the SCR catalyst composition may be disposed or supported on the substrate (i.e. the SCR catalyst composition is applied onto the substrate by a washcoating method).

When the SCR catalyst has a filtering substrate, then it is a selective catalytic reduction filter catalyst, which is referred to herein by the abbreviation “SCRF”. The SCRF comprises a filtering substrate and the selective catalytic reduction (SCR) composition. References to use of SCR catalysts throughout this application are understood to include use of SCRF catalysts as well, where applicable.

The selective catalytic reduction composition may comprise, or consist essentially of, a metal oxide based SCR catalyst formulation, a molecular sieve based SCR catalyst formulation, or mixture thereof. Such SCR catalyst formulations are known in the art.

The selective catalytic reduction composition may comprise, or consist essentially of, a metal oxide based SCR catalyst formulation. The metal oxide based SCR catalyst formulation comprises vanadium or tungsten or a mixture thereof supported on a refractory oxide. The refractory oxide may be selected from the group consisting of alumina, silica, titania, zirconia, ceria and combinations thereof.

The metal oxide based SCR catalyst formulation may comprise, or consist essentially of, an oxide of vanadium (e.g. V₂O₅) and/or an oxide of tungsten (e.g. WO₃) supported on a refractory oxide selected from the group consisting of titania (e.g. TiO₂), ceria (e.g. CeO₂), and a mixed or composite oxide of cerium and zirconium (e.g. CeₓZr₍₁₋ₓ₎O₂, wherein x=0.1 to 0.9, preferably x=0.2 to 0.5).

When the refractory oxide is titania (e.g. TiO₂), then preferably the concentration of the oxide of vanadium is from 0.5 to 6 wt % (e.g. of the metal oxide based SCR formulation) and/or the concentration of the oxide of tungsten (e.g. WO₃) is from 5 to 20 wt %. More preferably, the oxide of vanadium (e.g. V₂O₅) and the oxide of tungsten (e.g. WO₃) are supported on titania (e.g. TiO₂).

When the refractory oxide is ceria (e.g. CeO₂), then preferably the concentration of the oxide of vanadium is from 0.1 to 9 wt % (e.g. of the metal oxide based SCR formulation) and/or the concentration of the oxide of tungsten (e.g. WO₃) is from 0.1 to 9 wt %.

The metal oxide based SCR catalyst formulation may comprise, or consist essentially of, an oxide of vanadium (e.g. V₂O₅) and optionally an oxide of tungsten (e.g. WO₃), supported on titania (e.g. TiO₂).

The selective catalytic reduction composition may comprise, or consist essentially of, a molecular sieve based SCR catalyst formulation. The molecular sieve based SCR catalyst formulation comprises a molecular sieve, which is optionally a transition metal exchanged molecular sieve. It is preferable that the SCR catalyst formulation comprises a transition metal exchanged molecular sieve.

In general, the molecular sieve based SCR catalyst formulation may comprise a molecular sieve having an aluminosilicate framework (e.g. zeolite), an aluminophosphate framework (e.g. AlPO), a silicoaluminophosphate framework (e.g. SAPO), a heteroatom-containing aluminosilicate framework, a heteroatom-containing aluminophosphate framework (e.g. MeAlPO, where Me is a metal), or a heteroatom-containing silicoaluminophosphate framework (e.g. MeAPSO, where Me is a metal). The heteroatom (i.e. in a heteroatom-containing framework) may be selected from the group consisting of boron (B), gallium (Ga), titanium (Ti), zirconium (Zr), zinc (Zn), iron (Fe), vanadium (V) and combinations of any two or more thereof. It is preferred that the heteroatom is a metal (e.g. each of the above heteroatom-containing frameworks may be a metal-containing framework).

It is preferable that the molecular sieve based SCR catalyst formulation comprises, or consist essentially of, a molecular sieve having an aluminosilicate framework (e.g. zeolite) or a silicoaluminophosphate framework (e.g. SAPO).

When the molecular sieve has an aluminosilicate framework (e.g. the molecular sieve is a zeolite), then typically the molecular sieve has a silica to alumina molar ratio (SAR) of from 5 to 200 (e.g. 10 to 200), 10 to 100 (e.g. 10 to 30 or 20 to 80), such as 12 to 40, or 15 to 30. In some embodiments, a suitable molecular sieve has a SAR of >200; >600; or >1200. In some embodiments, the molecular sieve has a SAR of from about 1500 to about 2100.

Typically, the molecular sieve is microporous. A microporous molecular sieve has pores with a diameter of less than 2 nm (e.g. in accordance with the IUPAC definition of “microporous” [see Pure & Appl. Chem., 66(8), (1994), 1739-1758)]).

The molecular sieve based SCR catalyst formulation may comprise a small pore molecular sieve (e.g. a molecular sieve having a maximum ring size of eight tetrahedral atoms), a medium pore molecular sieve (e.g. a molecular sieve having a maximum ring size of ten tetrahedral atoms) or a large pore molecular sieve (e.g. a molecular sieve having a maximum ring size of twelve tetrahedral atoms) or a combination of two or more thereof.

When the molecular sieve is a small pore molecular sieve, then the small pore molecular sieve may have a framework structure represented by a Framework Type Code (FTC) selected from the group consisting of ACO, AEI, AEN, AFN, AFT, AFX, ANA, APC, APD, ATT, CDO, CHA, DDR, DFT, EAB, EDI, EPI, ERI, GIS, GOO, IHW, ITE, ITW, LEV, LTA, KFI, MER, MON, NSI, OWE, PAU, PHI, RHO, RTH, SAT, SAV, SFW, SIV, THO, TSC, UEI, UFI, VNI, YUG and ZON, or a mixture and/or an intergrowth of two or more thereof. Preferably, the small pore molecular sieve has a framework structure represented by a FTC selected from the group consisting of CHA, LEV, AEI, AFX, ERI, LTA, SFW, KFI, DDR and ITE. More preferably, the small pore molecular sieve has a framework structure represented by a FTC selected from the group consisting of CHA and AEI. The small pore molecular sieve may have a framework structure represented by the FTC CHA. The small pore molecular sieve may have a framework structure represented by the FTC AEI. When the small pore molecular sieve is a zeolite and has a framework represented by the FTC CHA, then the zeolite may be chabazite.

When the molecular sieve is a medium pore molecular sieve, then the medium pore molecular sieve may have a framework structure represented by a Framework Type Code (FTC) selected from the group consisting of AEL, AFO, AHT, BOF, BOZ, CGF, CGS, CHI, DAC, EUO, FER, HEU, IMF, ITH, ITR, JRY, JSR, JST, LAU, LOV, MEL, MFI, MFS, MRE, MTT, MVY, MWW, NAB, NAT, NES, OBW, -PAR, PCR, PON, PUN, RRO, RSN, SFF, SFG, STF, STI, STT, STW, -SVR, SZR, TER, TON, TUN, UOS, VSV, WEI and WEN, or a mixture and/or an intergrowth of two or more thereof. Preferably, the medium pore molecular sieve has a framework structure represented by a FTC selected from the group consisting of FER, MEL, MFI, and STT. More preferably, the medium pore molecular sieve has a framework structure represented by a FTC selected from the group consisting of FER and MFI, particularly MFI. When the medium pore molecular sieve is a zeolite and has a framework represented by the FTC FER or MFI, then the zeolite may be ferrierite, silicalite or ZSM-5.

When the molecular sieve is a large pore molecular sieve, then the large pore molecular sieve may have a framework structure represented by a Framework Type Code (FTC) selected from the group consisting of AFI, AFR, AFS, AFY, ASV, ATO, ATS, BEA, BEC, BOG, BPH, BSV, CAN, CON, CZP, DFO, EMT, EON, EZT, FAU, GME, GON, IFR, ISV, ITG, IWR, IWS, IWV, IWW, JSR, LTF, LTL, MAZ, MEI, MOR, MOZ, MSE, MTW, NPO, OFF, OKO, OSI, -RON, RWY, SAF, SAO, SBE, SBS, SBT, SEW, SFE, SFO, SFS, SFV, SOF, SOS, STO, SSF, SSY, USI, UWY, and VET, or a mixture and/or an intergrowth of two or more thereof. Preferably, the large pore molecular sieve has a framework structure represented by a FTC selected from the group consisting of AFI, BEA, MAZ, MOR, and OFF. More preferably, the large pore molecular sieve has a framework structure represented by a FTC selected from the group consisting of BEA, MOR and MFI. When the large pore molecular sieve is a zeolite and has a framework represented by the FTC BEA, FAU or MOR, then the zeolite may be a beta zeolite, faujasite, zeolite Y, zeolite X or mordenite.

The molecular sieve based SCR catalyst formulation preferably comprises a transition metal exchanged molecular sieve. The transition metal may be selected from the group consisting of cobalt, copper, iron, manganese, nickel, palladium, platinum, ruthenium and rhenium.

The transition metal may be copper. An advantage of SCR catalyst formulations containing a copper exchanged molecular sieve is that such formulations have excellent low temperature NOₓ reduction activity (e.g. it may be superior to the low temperature NOₓ reduction activity of an iron exchanged molecular sieve). Systems and method of the present invention may include any type of SCR catalyst, however, SCR catalysts including copper (“Cu-SCR catalysts”) may experience more notable benefits from systems of the present invention, as they are particularly vulnerable to the effects of sulfation. Cu-SCR catalyst formulations may include, for example, Cu exchanged SAPO-34, Cu exchanged CHA zeolite, Cu exchanged AEI zeolites, or combinations thereof.

The transition metal may be present on an extra-framework site on the external surface of the molecular sieve or within a channel, cavity or cage of the molecular sieve.

Typically, the transition metal exchanged molecular sieve comprises an amount of 0.10 to 10% by weight of the transition metal exchanged molecular, preferably an amount of 0.2 to 5% by weight.

In general, the selective catalytic reduction catalyst comprises the selective catalytic reduction composition in a total concentration of 0.5 to 4.0 g in⁻³, preferably 1.0 to 3.0 4.0 g in⁻³.

The SCR catalyst composition may comprise a mixture of a metal oxide based SCR catalyst formulation and a molecular sieve based SCR catalyst formulation. The (a) metal oxide based SCR catalyst formulation may comprise, or consist essentially of, an oxide of vanadium (e.g. V₂O₅) and optionally an oxide of tungsten (e.g. WO₃), supported on titania (e.g. TiO₂) and (b) the molecular sieve based SCR catalyst formulation may comprise a transition metal exchanged molecular sieve.

When the SCR catalyst is an SCRF, then the filtering substrate may preferably be a wall flow filter substrate monolith, such as described herein in relation to a catalyzed soot filter. The wall flow filter substrate monolith (e.g. of the SCR-DPF) typically has a cell density of 60 to 400 cells per square inch (cpsi). It is preferred that the wall flow filter substrate monolith has a cell density of 100 to 350 cpsi, more preferably 200 to 300 cpsi.

The wall flow filter substrate monolith may have a wall thickness (e.g. average internal wall thickness) of 0.20 to 0.50 mm, preferably 0.25 to 0.35 mm (e.g. about 0.30 mm).

Generally, the uncoated wall flow filter substrate monolith has a porosity of from 50 to 80%, preferably 55 to 75%, and more preferably 60 to 70%.

The uncoated wall flow filter substrate monolith typically has a mean pore size of at least 5 μm. It is preferred that the mean pore size is from 10 to 40 μm, such as 15 to 35 μm, more preferably 20 to 30 μm.

The wall flow filter substrate may have a symmetric cell design or an asymmetric cell design.

In general, for an SCRF, the selective catalytic reduction composition is disposed within the wall of the wall-flow filter substrate monolith. Additionally, the selective catalytic reduction composition may be disposed on the walls of the inlet channels and/or on the walls of the outlet channels.

Substrate

Catalysts of the present invention may each further comprise a flow-through substrate or filter substrate. In one embodiment, the catalyst may be coated onto the flow-through or filter substrate, and preferably deposited on the flow-through or filter substrate using a washcoat procedure.

The combination of an SCR catalyst and a filter is known as a selective catalytic reduction filter (SCRF catalyst). An SCRF catalyst is a single-substrate device that combines the functionality of an SCR and particulate filter, and is suitable for embodiments of the present invention as desired. Description of and references to the SCR catalyst throughout this application are understood to include the SCRF catalyst as well, where applicable.

The flow-through or filter substrate is a substrate that is capable of containing catalyst/adsorber components. The substrate is preferably a ceramic substrate or a metallic substrate. The ceramic substrate may be made of any suitable refractory material, e.g., alumina, silica, titania, ceria, zirconia, magnesia, zeolites, silicon nitride, silicon carbide, zirconium silicates, magnesium silicates, aluminosilicates, metallo aluminosilicates (such as cordierite and spudomene), or a mixture or mixed oxide of any two or more thereof. Cordierite, a magnesium aluminosilicate, and silicon carbide are particularly preferred.

The metallic substrates may be made of any suitable metal, and in particular heat-resistant metals and metal alloys such as titanium and stainless steel as well as ferritic alloys containing iron, nickel, chromium, and/or aluminum in addition to other trace metals.

The flow-through substrate is preferably a flow-through monolith having a honeycomb structure with many small, parallel thin-walled channels running axially through the substrate and extending throughout from an inlet or an outlet of the substrate. The channel cross-section of the substrate may be any shape, but is preferably square, sinusoidal, triangular, rectangular, hexagonal, trapezoidal, circular, or oval. The flow-through substrate may also be high porosity which allows the catalyst to penetrate into the substrate walls.

The filter substrate is preferably a wall-flow monolith filter. The channels of a wall-flow filter are alternately blocked, which allow the exhaust gas stream to enter a channel from the inlet, then flow through the channel walls, and exit the filter from a different channel leading to the outlet. Particulates in the exhaust gas stream are thus trapped in the filter.

The catalyst may be added to the flow-through or filter substrate by any known means, such as a washcoat procedure.

Urea Injector

The system may include a means for introducing urea to the heat exchange, and/or into the exhaust system upstream of the SCR and/or SCRF catalyst. As described herein, urea may be introduced to the surface of a heat exchanger by any suitable means. Suitable means may include an injector, sprayer, feeder, or an electronic liquid flow controller. Resulting ammonia may then be introduced into the exhaust system, such as upstream of the SCR or SCRF. In some embodiments, the ammonia is introduced directly upstream of the SCR or SCRF catalyst (e.g. there is no intervening catalyst between the means for introducing a nitrogenous reductant and the SCR or SCRF catalyst). The ammonia is then added to the flowing exhaust gas by any suitable means for introducing ammonia into the exhaust gas. Suitable means include an injector, sprayer, or feeder. Such means are well known in the art.

The exhaust system may also comprise a means for controlling the introduction of urea to the heat exchange and/or ammonia into the exhaust gas in order to reduce NOₓ therein. Preferred control means may include an electronic control unit, optionally an engine control unit, and may additionally comprise a NOₓ sensor located downstream of the SCR catalyst.

Filter

The exhaust system of the invention also comprises a particulate filter. Particulate filters are devices that reduce particulates from the exhaust of internal combustion engines. Particulate filters include catalyzed particulate filters and bare (non-catalyzed) particulate filters. Catalyzed particulate filters, also called catalyzed soot filters, (for diesel and gasoline applications) include metal and metal oxide components (such as Pt, Pd, Fe, Mn, Cu, and ceria) to oxidize hydrocarbons and carbon monoxide in addition to destroying soot trapped by the filter. The particulate filter is preferably a wall-flow filter.

The filter and SCR catalyst can be arranged in any suitable configuration. For instance, the SCR catalyst may be located downstream of the filter. The means for introducing ammonia into a flowing exhaust gas is suitably located between the filter and the SCR catalyst.

The SCR catalyst may be located on the particulate filter, such as in the form of a selective catalytic reduction filter (SCRF). Where the filter is a wall-flow filter, the SCR catalyst can be formulated as a washcoat that permeates the walls of the filter. This can be done, for example, by milling the catalyst to an average particle size of ≤5 μm.

Oxidation Catalyst

Systems of the present invention may include one or more oxidation catalysts. Oxidation catalysts, and in particular diesel oxidation catalysts (DOCs), are well-known in the art. Oxidation catalysts are designed to oxidize CO to CO₂ and gas phase hydrocarbons (HC) and an organic fraction of diesel particulates (soluble organic fraction) to CO₂ and H₂O. An NO oxidation catalyst is useful for oxidizing NO to nitrogen dioxide. Typical oxidation catalysts include platinum and optionally also palladium on a high surface area inorganic oxide support, such as alumina, silica-alumina and a zeolite.

An oxidation catalyst may be located, for example, upstream of a filter and/or the SCR catalyst, relative to the direct of exhaust gas flow through the system.

The oxidation catalysts may be substituted for an active NOx adsorbing catalyst, requiring periodic rich regeneration, or a diesel cold start catalyst (dCSC™). In both cases, low temperature NOx aftertreatment is performed in conjunction with diesel exhaust oxidation activities.

Ammonia Oxidation Catalyst

Systems of the present invention may include one or more ammonia oxidation catalysts, also called an ammonia slip catalyst (“ASC”). One or more ASC may be included downstream from an SCR catalyst, to oxidize excess ammonia and prevent it from being released to the atmosphere. In some embodiments, the ASC may be located upstream of the EGR, relative to the direct of exhaust gas flow through the system. In some embodiments, the SCR catalyst and the ammonia oxidation catalyst may be loaded onto the same substrate, wherein the SCR catalyst is located on an inlet end and the ammonia oxidation catalyst is located on an outlet end. In certain embodiments, the ammonia oxidation catalyst material may be selected to favor the oxidation of ammonia instead of the formation of NOₓ or N₂O. Preferred catalyst materials include platinum, palladium, or a combination thereof, with platinum or a platinum/palladium combination being preferred. Preferably, the ammonia oxidation catalyst comprises platinum and/or palladium supported on a metal oxide. Preferably, the catalyst is disposed on a high surface area support, including but not limited to alumina.

System Configurations

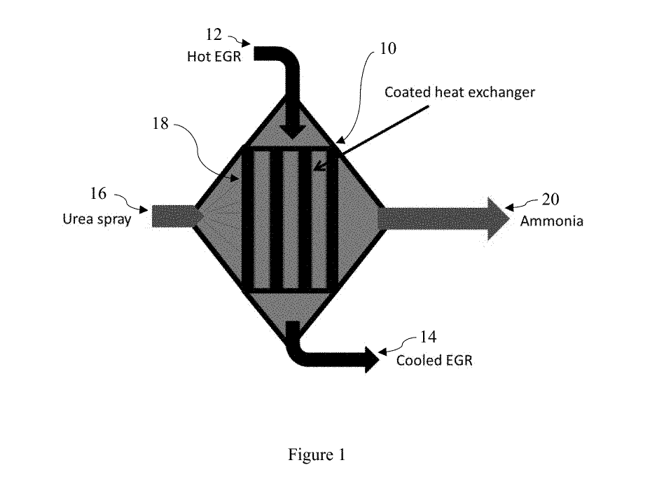

FIG. 1 shows one embodiment of the invention, showing a cross section of heat exchanger 10. Hot EGR gas 12 flows into and through heat exchanger 10, and exits heat exchanger 10 as cooled EGR gas 14. Urea injector 16 provides urea to a catalyzed surface 18 of heat exchanger 10. Heat from hot EGR gas 12 assists with the conversion of urea to ammonia 20. The resulting ammonia 20 exits heat exchanger 10 to be injected into the exhaust gas.

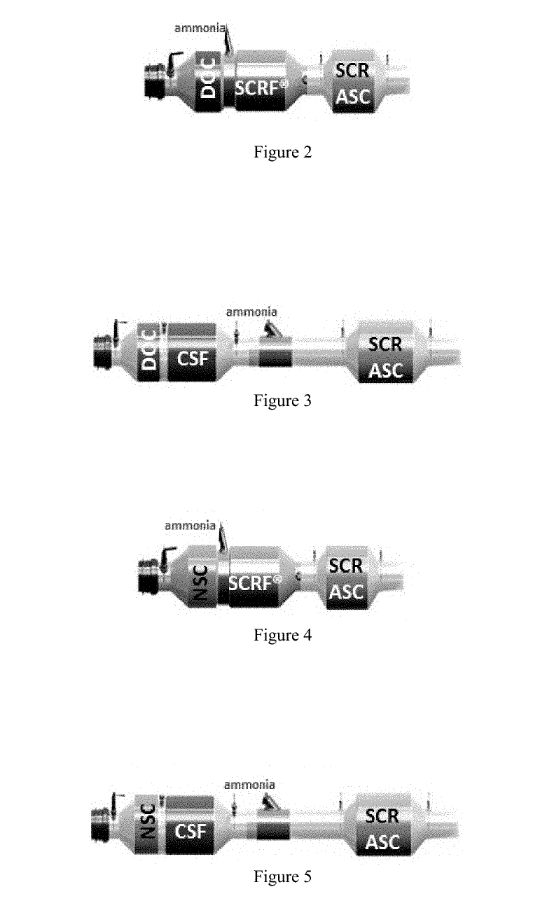

In some embodiments, the exhaust system may comprise a variety of different configurations prior to the EGR circuit. As shows in FIG. 2, a system may include a diesel oxidation catalyst (DOC), followed by a means for introducing a nitrogenous reductant such as ammonia, followed by an SCR filter and an SCR/ammonia oxidation catalyst. As shown in FIG. 3, a system may include a DOC followed by a catalyzed particulate filter, a means for introducing a nitrogenous reductant, then an SCR/ammonia slip catalyst. As shown in FIG. 4, a system may include a NOx storage catalyst, followed by a means for introducing a nitrogenous reductant, followed by an SCRF, then an SCR/ammonia oxidation catalyst. As shown in FIG. 5, a system may include a NOx storage catalyst, followed by a catalyzed particulate filter, followed by a means for introducing a nitrogenous reductant then an SCR/ammonia oxidation catalyst; and other possible combinations.

The system may then comprise a high or low pressure exhaust gas recirculation (EGR) circuit for connecting the exhaust system downstream of the filter and the NOₓ reduction catalyst to an intake of the engine, integrating the heat exchanger shown in FIG. 1.

1. An exhaust system for an internal combustion engine, the system comprising
a. an exhaust gas recirculation (EGR) circuit for connecting an exhaust stream to an intake of the engine, wherein the EGR circuit comprises a heat exchanger and the heat exchanger includes a surface comprising a urea hydrolysis catalyst;
b. a urea injector for providing urea to the surface of the heat exchanger coated with the urea hydrolysis catalyst, and means for introducing resulting ammonia to the exhaust stream.

2. The exhaust system of claim 1, wherein the EGR circuit is a low pressure EGR circuit.

3. The exhaust system of claim 1, wherein the EGR circuit is a high pressure EGR circuit.

4. The exhaust system of claim 1, wherein the heat exchanger includes a surface contacted by the exhaust stream, which is catalytically coated to discourage soot accumulation.

5. The exhaust system of claim 1, further comprising a selective catalytic reduction (SCR) catalyst, wherein the ammonia is introduced upstream of the SCR catalyst.

6. The exhaust system of claim 5, wherein the selective catalytic reduction catalyst comprises a transition metal and molecular sieve.

7. The exhaust system of claim 5, further comprising an ammonia oxidation catalyst disposed downstream of the SCR catalyst, relative to the direction of exhaust gas flow through the system.

8. The exhaust system of claim 7, wherein the SCR catalyst and the ammonia oxidation catalyst are loaded onto the same substrate, wherein the SCR catalyst is located on an inlet end and the ammonia oxidation catalyst is located on an outlet end.

9. The exhaust system of claim 1, further comprising a particulate filter.

10. A lean-burn internal combustion engine comprising an exhaust system according to claim 1.

11. A compression ignition engine according to claim 10.
